(19) United States
(12) Patent Application Publication
(10) Pub. No.: US 2006/0123937 A1
(43) Pub. Date: Jun. 15, 2006

(54) Centrifugal generator of a thrust force for aviation and space apparatuses

(76) Inventors: Mikhail Tsepenyuk, Brooklyn, NY (US); Dmitry Tsepenyuk, Brooklyn, NY (US); Irene Tsepenyuk, Brooklyn, NY (US)

Correspondence Address: Ilya Zborovsky, 6 Schoolhouse Way, Dix Hills, NY, 11746, US

(21) Appl. No.: 11/011,539

(22) Filed: Dec. 14, 2004

(51) Int. Cl. F16H 27/04

(52) U.S. Cl. 74/84 S

(57) ABSTRACT

A centrifugal generator of a thrust force for aviation and space application has a housing, an integrating element, work masses, a drive, the integrating element being composite and arranged in the housing with a possibility of a forced reciprocating displacement along parallel guides and has an annular guide formed by two identical annular grooves which surround console parts of the work mass with a clearance, the drive being formed as a lever-type drive with floating rods, that are provided with end stops with dampers and extending through an axis of a shaft and central parts of the work masses, the rods being arranged in pairs parallel to one another and in the pairs are located at a same distance from an axis of symmetry of the drive and arranged in pairs with a uniform angle of displacement, the rods interacting with the shaft and the work masses through sliding bearings, the rods having a length which provides a clearance of the console parts of the work masses when the console parts of opposite ones of the work masses are in contact in a position of a maximum distance from one another.

### BACKGROUND OF THE INVENTION

The present invention relates to a construction of a device for generation of a thrust force, and in particular to a construction of a centrifugal generator of a thrust force for aviation and space apparatuses.

A device of the above mentioned type which is a propeller is known in the art. It includes aerodynamic vanes which are located in a housing with a possibility of turning around a longitudinal axis and a power mechanism providing the turning. The propeller has been used in constructions of power sources of flying apparatuses for various purpose due to the simplicity of its construction, reliability and efficiency. The propeller however has the disadvantage in lowering of a thrust force with an increase of a flight speed and flight height.

A jet engine method of obtaining a thrust force is also widely used in aviation and space apparatuses. Devices which provide obtaining of a jet or reactive thrust force include a diffusor (a narrowing nozzle), or a Laval nozzle, a mechanism providing a change of a throughflow cross-section depending on a speed and a system of reverse of the thrust force. When the preliminarily compressed and heated gas passes through the nozzle, the thrust force is generated. The use of the reactive method for obtaining the thrust force allows the flying apparatus to reach great flight speeds and is nowadays the only technological solution for performing space flights.

It however has however the disadvantage in reduction of power with an increase of a flight speed; low efficiency; necessity to provide fuel and oxidants during flights and maneuvering in a space, supplied from the earth.

A centrifugal method of obtaining a thrust force is known, which is disclosed for example in French patent no. 933,483 and in U.S. Pat. No. 4,712,439. The construction disclosed in these references includes a housing, and work masses and an integrating element which are moved by a disc drive and provide movement of the work masses along a certain trajectory, and also add all centrifugal forces which are generated during this movement in the working masses. The sum of these forces constitutes a thrust force of the apparatus.

This construction has the advantages residing in independence of a thrust force and power from the flight speed and other external parameters, since the thrust force is generated by the interaction of the movable work masses and the integrating element, whose mutual location is constant; and simplicity of construction which provides a reliability.

However, this solution has the disadvantages in great inertia of the construction, which leads to difficulties during braking of the transporting means; and impossibility of regulation of the thrust force both with respect to its absolute value and its direction.

### SUMMARY OF THE INVENTION

Accordingly, it is an object of the present invention to provide a centrifugal generator of a thrust force for aviation and space apparatuses which is a further improvement of the existing generators.

More particularly, it is an object of the present invention to provide a generator of a thrust force, which has a highly efficient parameters for use in flight apparatuses, including space apparatuses.

In keeping with these objects and with others which will become apparent hereinafter, one feature of the present invention resides, briefly stated, in a centrifugal generator of a thrust force for aviation and space application, comprising a housing; an integrating element; work masses; a drive, said integrating element being composite and arranged in said housing with a possibility of a forced reciprocating displacement along parallel guides and has an annular guide formed by two identical annular grooves which surround console parts of said work masses with a clearance, said drive being formed as a lever-type drive with floating rods, that are provided with end stops with dampers and extending through an axis of a shaft and central parts of said work masses, said rods being arranged in pairs parallel to one another and in said pairs are located at a same distance from an axis of symmetry of said drive and arranged in pairs with a uniform angle of displacement, said rods interacting with said shaft and said work masses through sliding bearings, said rods having a length which provides a clearance of said console parts of said work masses when said console parts are in contact with opposite work masses in a position of a maximum distance from one another.

When the generator is designed in accordance with the present invention, it has parameters which are necessary for its use in constructions of flight apparatuses, such as aviation and space apparatuses.

In accordance with a further feature of the present invention, the generator, for obtaining parameters which are necessary for the use of the lying apparatus for vertical lift off and landing, the composite integrating elements together with a mechanism of a reciprocating movement and said parallel guides are arranged in said housing with said possibility of a forced rotary movement over an angle +/−90° relative to said axis of rotation of said drive.

In accordance with a further feature of the present invention, the masses have a central part which is formed as an aerodynamic profile. This provides an increase of efficiency of the centrifugal generator during its exploitation in an air space.

In accordance with still a further feature of the present invention the generator has means for mounting on a space apparatus with a possibility of a forced turning by an angle +/−90° relative to an axis which is perpendicular to said shaft of said drive.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 are a side view and a top view of a centrifugal generator of a thrust force for an airplane in a lift off mode, in accordance with the invention;

FIG. 3 is a top view of the centrifugal generator for generation of a thrust force for an airplane in a reverse mode, in accordance with the present invention;

FIG. 4 is a plan view of the centrifugal generator for generating a thrust force for an airplane in a zero thrust mode in accordance with the present invention;

FIGS. 5 and 6 are a side view and a top view of a centrifugal generator for generating a thrust force for a flying apparatus for a vertical lift off and landing in a lift off mode in accordance with the present invention;

FIGS. 7 and 8 are a top view of the centrifugal generator for generating a thrust force for a flying apparatus of a vertical lift off and landing, in a mode of changing a thrust vector, in accordance with the present invention;

FIGS. 9 and 10 are a front view and a side view of a work mass with a central part, formed as an aerodynamic profile; and

FIG. 11 is a top view of the centrifugal generator for generating a thrust force for space flight apparatuses.

### DESCRIPTION OF THE PREFERRED EMBODIMENT

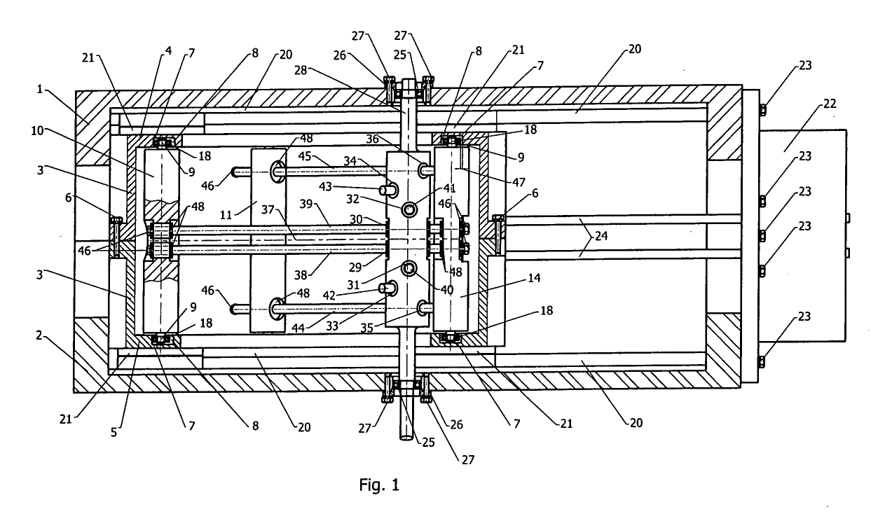

A centrifugal generator of a thrust force for flying apparatuses, such as an airplane, shown in FIGS. 1-4, is composed of a composite housing having two parts 1 and 2 connected by bolts 3 to form a single structure. It also includes an integrating element which is also composed of two parts 4 and 5 connected by bolts 6. Identical annular guides 7 are formed in the parts 4 and 5 of the integrating element as a grooves having a rectangular cross-section, which, with a gap 8 shown in FIG. 1, surround console parts 9 of work masses 10, 11, 12, 13, 14, 15, 16 and 17 together with roller bearings 18 arranged on the console parts 9.

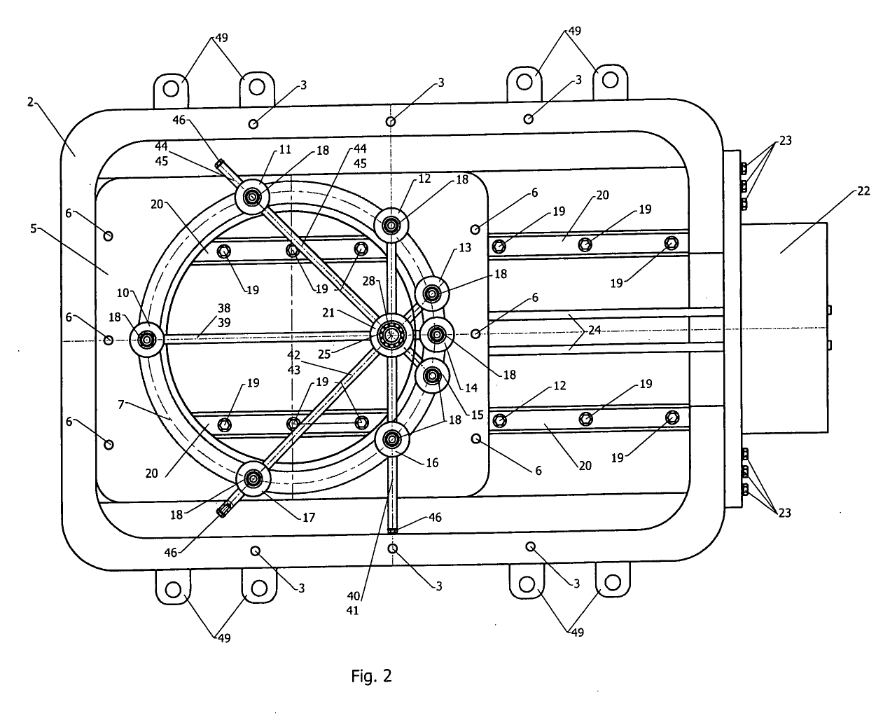

Rails 20 are arranged on the inner surface of the parts 1 and 2 of the housing by means of bolts 19 shown in FIG. 2, and carriages 21 are arranged on the outer surfaces of the parts 4 and 5 of the integrating element. The carriages 21 and the rails 20 form parallel guides. A power mechanism 22 is arranged on the parts 1 and 2 of the housing and fixed by bolts 23.

The power mechanism 22, by means of rods 24, is connected with the parts 4 and 5 of the integrating element. Bearing supports are provided on the parts 1 and 2 and composed directly of roller bearings 25, fixing flanges 26 and mounting bolts 27. A shaft 28 is arranged on the bearing supports.

The shaft 28 is provided with sliding bearings 29, 30, 31, 32, 33, 34, 35, and 36 shown in FIG. 1. They are arranged in pairs 29 and 30, 31 and 32, 33 and 34, 35 and 36 parallel and spaced in pairs at the same distances from an axis of symmetry 37 shown in FIG. 1, and also in pairs with a uniform angular offset.

The sliding bearings 29-36 provide mounting of float rods 38-45 with the possibility of reciprocating movement, while the floating rods 38-45 and the sliding bearings 29-36 are arranged in pairs 38 and 39, 40 and 41, 42 and 43, 44 and 45 parallel, in pairs spaced by equal distance from the axis of symmetry 37 shown in FIG. 1 and in pairs with a uniform angular offset.

Each floating rod 38-45 is provided with two end stops 46. Each pair of the floating rods 38 and 39, 40 and 41, 42 and 43, 44 and 45 interacts correspondingly with two work masses 10 and 14, 12 and 16, 13 and 17, 11 and 15 which are arranged between the end stops 46 and the shaft 28 and provided with a pair of sliding bearings 48 as shown in FIG. 1, that provide a possible displacement of the floating rods 38-45 in a radial direction.

The floating rods 38-45 are formed with an identical length so as to provide a gap 47 shown in FIG. 1 between the roller bearings 18 mounted on the console parts 9 of the work masses 10-17 and the surfaces of the guides 7, with a maximum distance of the working masses of each pair 10 and 14, 12 and 16, 13 and 17, 11 and 15 relative to one another. In FIG. 1—these are the working masses 10 and 14.

Each working mass 10-17 is provided with two sliding bearings 48 which are located in pairs, with an equal distance between them for each pair of the work masses 10 and 14, 12 and 16, 13 and 17, 11 and 15, and corresponding to the distance between the pairs of the floating rods 38 and 39, 40 and 41, 42 and 43, 44 and 45 which interact with them.

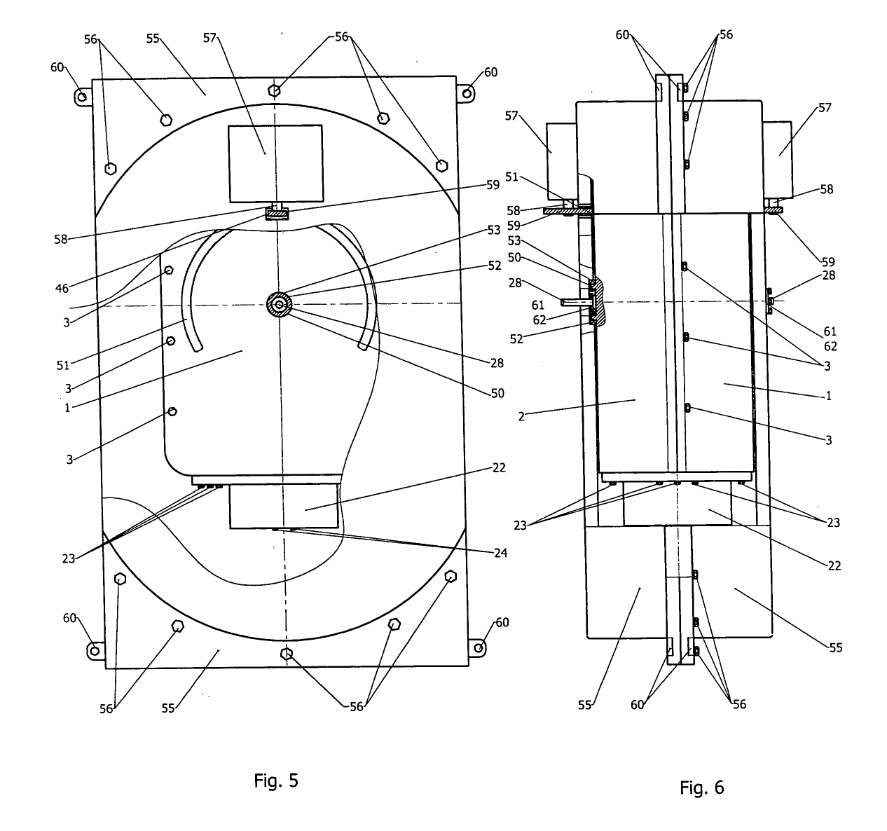

A lug of suspension 49 shown in FIG. 1 is arranged on the parts 1 and 2 of the housing. They are used for mounting of the centrifugal generator of a thrust force on a flying apparatus. The centrifugal generator of a thrust force for a flying apparatus of a vertical lift off and landing shown in FIGS. 5-8 is different from the centrifugal generator of the thrust force of the airplane shown in FIGS. 1-4 in that, cylindrical projections 50 are formed on the parts 1 and 2 of the housing coaxial to the shaft 28, and annular tooth racks 51 are provided. Supporting bearings 52 are arranged on the cylindrical projections 50 which, by means of the flanges 61 and openings 62, interact with the surfaces of the openings 53 to form formed in a surrounding housing 55.

The surrounding housing 55 is composed of two parts connected by bolts 56 to form a single structure. Engines 57 are arranged on the housing 55, and their axes 58 carry toothed wheels 59, which through the openings 54 in the housing 55 interact with the annular tooth racks 51. Suspensions 60 for mounting on a flying apparatus are provided on the housing 55.

The centrifugal generator of the thrust force shown in FIGS. 1-4 is mounted on an airplane by means of the units of the suspension so that the rails 20 are parallel to the axis of symmetry and the shaft 28 is connected to an engine (the diagram of mounting and the motor are not shown in the drawings). It operates in the following manner.

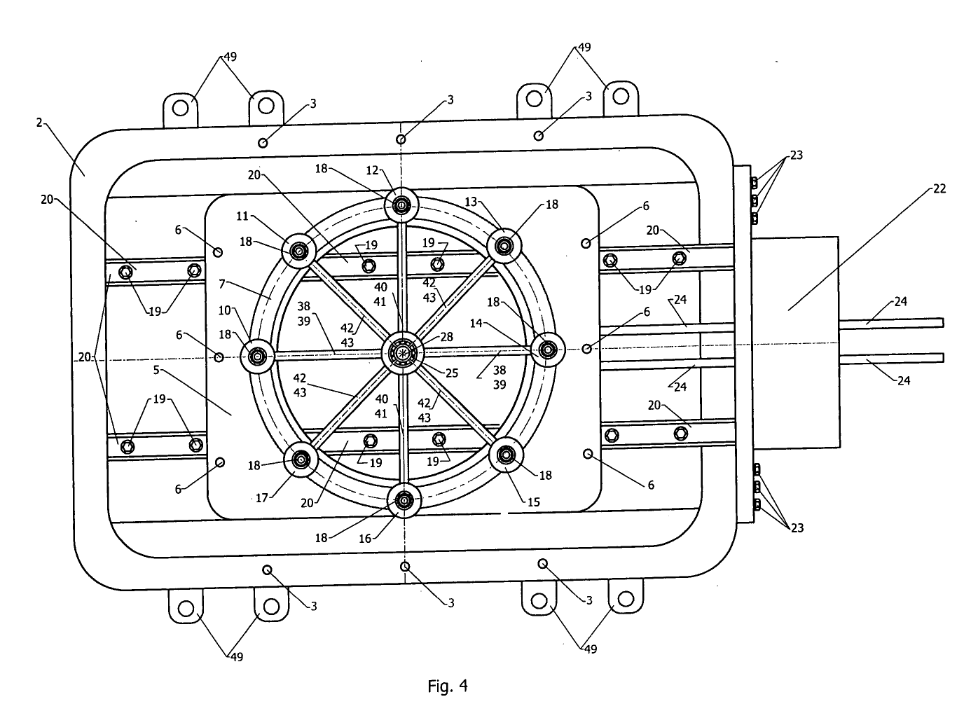

Before turning of the shaft 28 of the centrifugal generator of the thrust force, the parts 4 and 5 of the integrating elements are set along the rails 20 by means of a power mechanism 22 and the rods 24, to a position of a zero thrust shown in FIG. 4. The position of the zero thrust is characterized by equal distances of the work masses 10-17 from the axis of rotation of the shaft 28, and coincidence of this axis with the centers of gravity of the floating rods 38-45.

During turning of the shaft 28, under the action of torque of the engine, the floating rods 45 and work masses 10-17 are driven in rotation. All rotating elements generate centrifugal forces. The centrifugal forces generated by the work masses 10-17, with the consideration of the mass of the sliding bearings 48 and roller bearings 18 incorporated in them which are spaced by equal distances from the axis of rotation of the shaft 28 equal in accordance with the absolute value, act through the console parts 9 and the rolling bearing 18 on the surfaces of the annular guides 7 of the parts 4 and 5 of the integrated element.

The surfaces of the annular guide 7 of the parts 4 and 5 of the integrated element receive the centrifugal forces of the work masses 10-17 and provide a vector summing of these centrifugal forces. The vector sum of the centrifugal sources generated by the work masses 10-17 is equal to zero, since they are located with an equal angular offset relative to one another as shown in FIG. 5. The sum of the centrifugal forces generated by the floating rods 38-45 is equal to zero, since the centers of gravity of the latter coincide with the axis of rotation of the shaft 28.

In order to provide a lift off of an airplane, the parts 4 and 5 of the integrating element are displaced on the rails 20 under the action of the power mechanism 22 and the rods 24 in direction of movement of the airplane (FIGS. 1, 2) to a maximum possible distance, which is predetermined by the construction of the centrifugal generator of the thrust force. This displacement of the parts 4 and 5 of the integrating element results in a mutual displacement of the work masses 10-17, which with its console parts 9 with the rolling bearings 18 interact with the surfaces of the annular guides 7 formed on parts 4 and 5 of the integrating element. The mutual displacement of the work masses 10-17 results in a change of the position of the floating rods 38-45, which with the end stops 49 interact with the central parts of the work masses 10-17.

The possibility of the mutual displacement of the parts 4 and 5 of the integrating element, the work masses 10-17 and the floating rods 38-45 relative to one another, of the shaft 28 and the parts 1, 2 of the housing is provided by the presence of the gaps 8 of the sliding bearings 29-36 and 48. The mutual displacement of the parts 4 and 5 of the integrating element and the change of the parameters of movement of the work masses 10-17, as well as of the floating rods 38-45 causes the generation of a maximum thrust force for this construction.

The work masses 10-17 shown in FIGS. 1-2 move with a constant angular speed and with a variable linear speed. The farther work mass from the axis of rotation of the shaft 28, the greater linear speed of this work mass, the great centrifugal force generated by this mass and received by the parts 4 and 5 of the integrating element. The maximum centrifugal force in the moment shown in FIGS. 1 and 2 is generated by the work mass 10, while the minimum centrifugal force is generated by the work mass 14.

A vector sum of all centrifugal forces generated by the work masses 10-17 is now not equal to a zero value, and directed toward the displacement of the parts 4 and 5 of the integrating element. The displacement of the centers of gravity of the floating rods 38-45 in direction of the displacement of the parts 4 and 5 of the integrating elements generates in them also centrifugal forces, since theoretically the movement of the centers of gravity is an instantaneous rotary movement.

The vector sum of these centrifugal forces is also directed toward the displacement of the parts 4 and 5 of the integrating element, i.e. in direction of the displacement of the centers of gravity. The centrifugal forces from the floating rods 38-45 through the end stops 46 act on the center parts of the work masses 10-17 and through the console parts 9 and the sliding bearings 18, are transmitted to the annular guides 7 of the parts 4 and 5 of the integrating element. For example, the centrifugal forces generated in the floating rods 38 and 39 interact through the stops 46 with the work mass 14. The vector of the centrifugal force generated by floating rods 38 and 39 is directed to a side which is opposite to the vector of the centrifugal force generated by the work mass 14.

Depending on the absolute value of these centrifugal forces, either the force acting on the surface of the annular guide 7 from the work mass 14 is reduced, or the forces generated by the floating rods 38 and 39 and the work mass 14 will act on the opposite side of the annular guide 7 of the parts 4 and 5 of the integrating element.

Since the displacement of the parts 4 and 5 of the integrating element is maximal in FIGS. 1 and 2, therefore the vector sum of all generated centrifugal forces is also maximal.

The centrifugal forces generated by the work masses 10-17 and the floating rods 38-45 are summed by the parts 4 and 5 of the integrating elementm and this vector sum of the forces from the parts 4 and 5 of the integrating element is transmitted through the rods 24 to the power mechanism 22 and further to the parts 1 and 2 of the housing and through the units of suspension 49 to the airplane.

For performing a flight of the airplane in accordance with the cruise mode or for performing landing, an intermediate position of the parts 4 and 5 of the integrating element is used (not shown in the drawings).

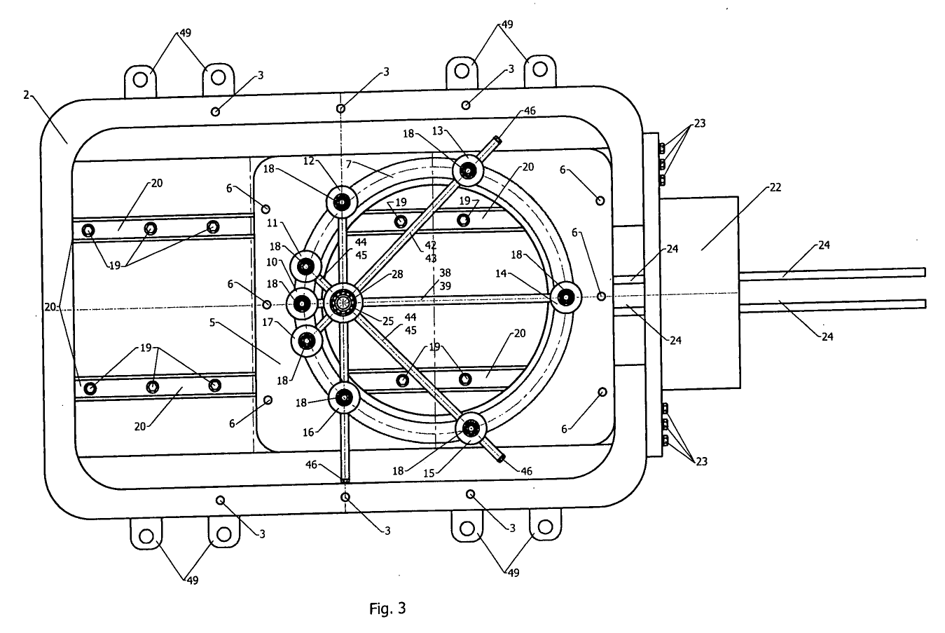

For reducing the landing distance of the airplane with the centrifugal generator of a thrust force, the parts 4 and 5 of the integrating element are displaced along the rails 20 by means of the power mechanism 22 and the rods 24 in direction which is opposite to the movement of the airplane as shown in FIG. 3. The centrifugal generator of the thrust force for the airplane generates the thrust force in the same way as during a lift off mode, but the generator thrust force is directed in an opposite direction.

The centrifugal generator of the thrust force shown in FIGS. 1-8 is provided for the use on air planes with a vertical lift off and landing. The centrifugal generators of the thrust force of this type are placed on a flying apparatus by means of the units 60. During the setting, the axes of symmetry of the parts 1 and 2 of the housing and of the surrounding housing 50 must be placed perpendicular to the axis of the symmetry of the flying apparatus, and the shaft 28 must be parallel to the horizontal plane. In this position the shaft 28 through the drive is connected to the engine.

Similarly to the centrifugal generator of a thrust force for the airplane, the turning of the shaft 20 and the work masses 10-18 connected to it and the floating rods 38-45 is performed in the position of the parts 4 and 5 of the integrating element, corresponding to the position of the zero thrust shown in FIG. 4.

When required rotary speed and readiness for lift off are achieved, the parts 4 and 5 of the integrating element are displaced by means of the power mechanism 22 and the rods 24 along the rails 20 vertically upwardly to a maximum possible distance which is predetermined by the construction, ie. to the position of a maximum thrust directed upwardly. When the thrust force exceeds the weight of the flying airplane, it takes off from the ground and vertically gains height with zero speed of flight.

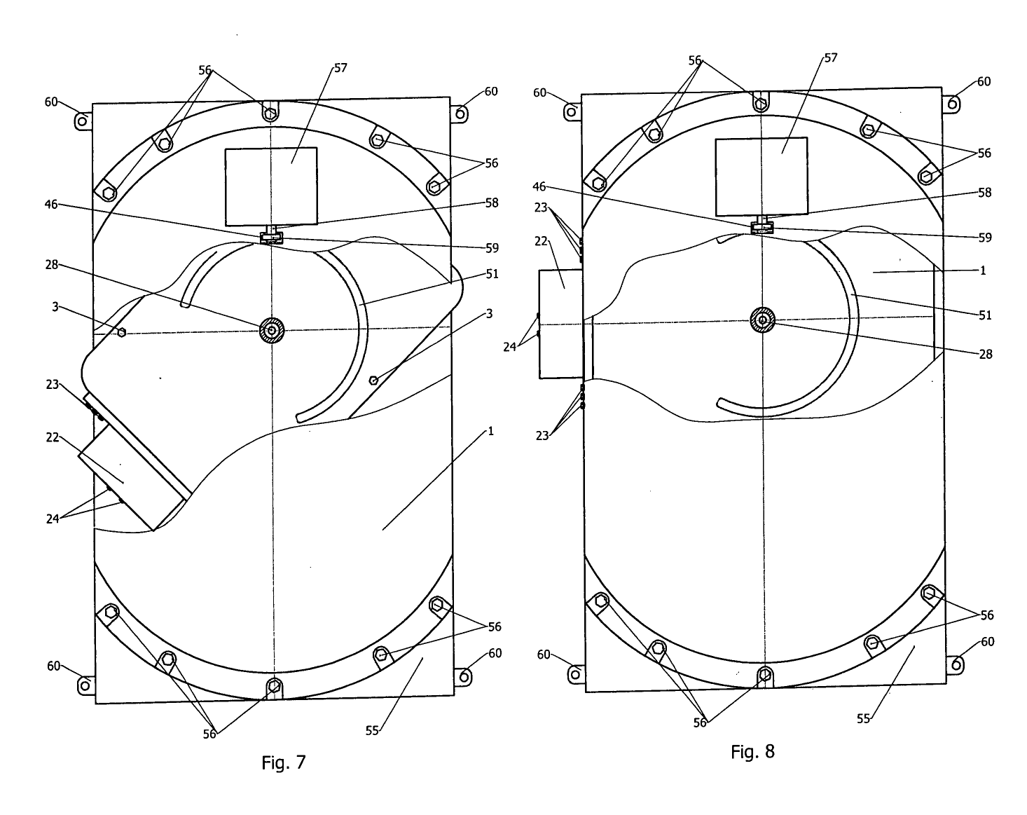

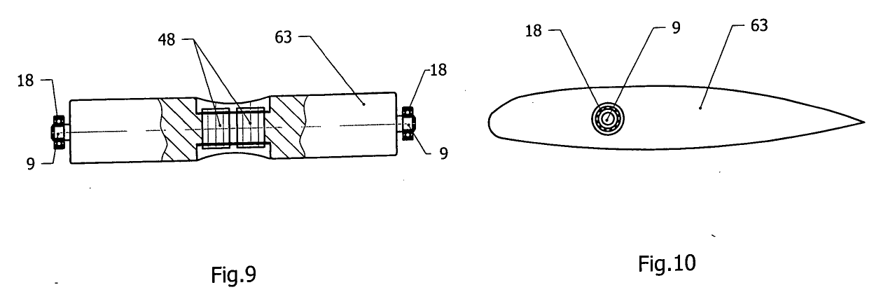

For speeding of the airplane of the vertical lift off and landing, the motors 57 are utilized, that by means of the axes 58 and toothed wheels 59 act on the toothed rack 51, and turn the parts 1 and 2 of the housing 1 and 2 relative to the surrounding housing 50, together with work masses 10-17, floating rods 38-45, the parts 4 and 5 of the integrating elements, rails 20 and power mechanism 22, as shown in FIGS. 7 and 8. The turning of the parts 1 and 2 of the housing is performed around the projections 50 with the use of the bearings 52. The coaxiality of the projections 50 with the shafts 28 provides this turning without a change of the position of the motor of the flying apparatus shown in FIGS. 7, 8.

The generation of a horizontal component of the thrust force provides an acceleration of the flying apparatus and occurrence of aerodynamic lifting force of the ring. During the process of increasing a lifting force generated by a wing, the angle of turning of the parts 1 and 2 of the housing is increased synchronously. For achieving a maximum speed of flight, the turning of the parts 1 and 2 of the housing by 90° is performed, as shown in FIG. 8.

A horizontal flight of such a flying apparatus with the use of the centrifugal generator of a thrust force is performed identically to the airplane (see operation of the centrifugal generator of a thrust force for the airplane).

The landing of the flying apparatus of the vertical lift off and landing in a mode of a zero horizontal speed is performed in the following sequence.

The elimination of the horizontal speed is performed by turning by 180° in an opposite direction by means of the motor 51 of the parts 1 and 2 of the housing. In the process of reduction of a horizontal speed, the turning of the parts 1 and 2 is performed synchronously in a direction of light, so that with the zero horizontal speed, the axis of symmetry of the parts 1 and 2 of the housing coincides with the axis of symmetry of the surrounding housing.

After this, by means of the power mechanism 22, the parts 4 and 5 of the integrating element are displaced in direction of the shaft 28 till a moment, when a generated thrust force of the centrifugal generator will be equal to a weight of the flying apparatus. By manipulations of a position of the parts 4 and 5, or in other words by changing a magnitude of a force generated by the centrifugal generator, the required speed of lowering and landing is imparted to the flying apparatus of a vertical lift off and landing.

The centrifugal generators of a thrust force with a drive of a lever type with floating rods, can be used in constructions of a flying apparatus, that have technical characteristics of helicopters. The centrifugal generator of a thrust force can be used for an airplane as a source of a lifting force, for which purpose it is located vertically. With the use of the generator of a thrust force for flying apparatuses for a vertical lift off and landing shown in FIGS. 5-8 at the source of a thrust in horizontal plane, which is installed on the flying apparatus so that a turning of the components of the housing 1 and 2 together with the components of the integrating element 4 and 5 is performed in a horizontal plane of the flying apparatus, the flying apparatus obtains technical-technical characteristics which characterize a helicopter.

The centrifugal generator of a thrust force for the airplanes shown in FIGS. 1-4 provides a vertical lift off and landing of the flying apparatus.

The centrifugal generator of a thrust force for the flying apparatuses of a vertical lift off and landing shown in FIGS. 5-8 provides a rectilinear displacement of the flying apparatus, wherein the reciprocating and rotating movement of the components 4 and 5 of the integrating element provides a rectilinear displacement of the flying apparatus in any direction and with any speed within the limits of calculated data, which are characteristic from the construction of the flying apparatus and of the centrifugal generators of a thrust force.

The capability of the centrifugal generator of a thrust force to generate a thrust during a rotary movement of the shaft 28 and movement of work masses 10-17 and floating rods 28-35 without interaction with a surrounding medium makes possible their use in constructions of space apparatuses for acceleration, braking and maneuvering.

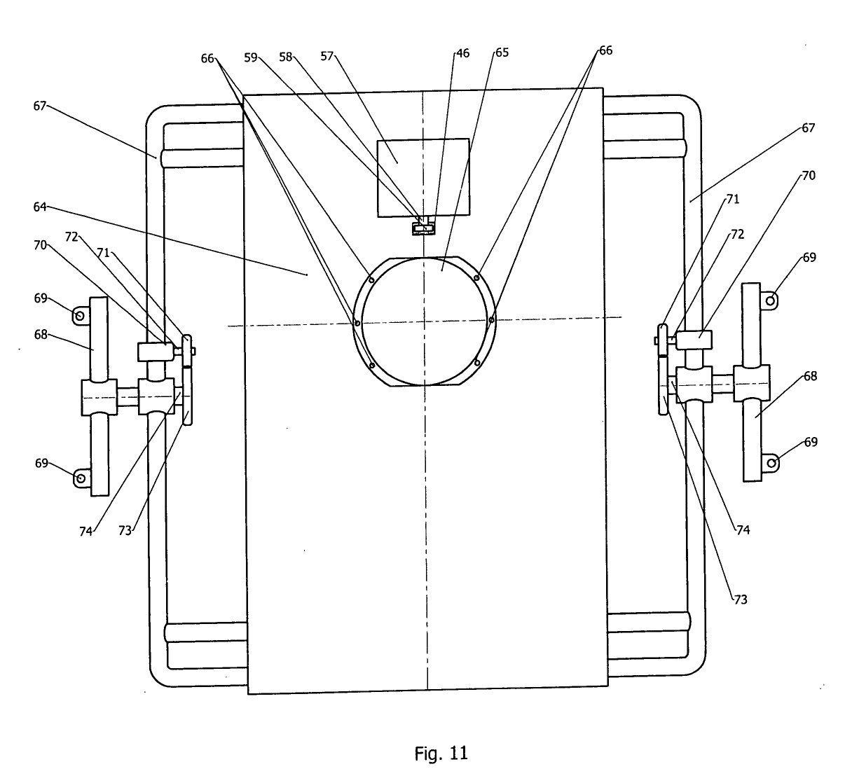

For the use of the centrifugal generators of a thrust force for space apparatuses, it is advisable, as shown in FIG. 11, to use the centrifugal generator with the system of regulation of a reverse of thrust and a vector of thrust as shown in FIGS. 5-8, by placing it with a possibility of turning together with the motor.

One of the variants of this construction includes a centrifugal generator of a thrust force 64 with a construction which is similar to the construction of the centrifugal generator of a thrust force for flying apparatuses of a vertical lift off and landing shown in FIGS. 5-8, on which an electric motor 65 is placed by means of the bolts 66. The electric motor 65 is connected to the shaft 28, not shown in the drawing. The housing adjusts the motor current, from which the torque component depending on the motor current is produced, to such a limiting value, that with consideration of the rotary speed-dependent with consideration of the rotary speed-dependent torque component, the predetermined maximum permissible torque is not exceeded.

The housing of the centrifugal generator of a thrust force 64 is fixedly connected to the frame 67. Motors 70 are mounted on the frame 67 and, through the axles 72 and toothed gears 71 and 73, are connected by mounting units 69 and 68 through shafts 74. This provides for a turning of the centrifugal generator of a thrust force 64, together with the frame 67 and the motors 57 and 68 around an axis of the shaft 74.

This construction of mounting of the centrifugal generator of a thrust force in combination with the construction of the centrifugal generator 64 itself provides for a possibility to generate a thrust force in any direction. The use of the motors and power mechanisms operating on electrical energy which can be produced in space, makes possible to provide an autonomous power plant for space apparatuses.

When the centrifugal generators of a thrust force are used for flying apparatuses, the most suitable motor can be an internal combustion engine or a gas-turbine engine with a free turbine (turboshaft).

Centrifugal generators of a thrust force with a drive of a lever type can qualitatively change a tactical-technical characteristics of flying apparatuses of any type and application.

The independence of a thrust force generated by the centrifugal generators of a thrust force, from a flight speed, conditions of surrounding medium, and its location in a construction of the flying apparatus with a high efficiency when compared with other apparatuses, for generation of a thrust force, make possible to use it in constructions of other transporting means as well.

Efficiency of any apparatus for generating a thrust force is usually evaluated by a relationship between a thrust force and a spent power for obtaining the same.

Main consumptions of power during the operation of the centrifugal generator of a thrust force with a drive of lever type is spent for overcoming friction forces, created between the surfaces of the ring guides 7 and roller bearings 18, and also during a mutual displacement of the floating rods 38-45 relative to the work masses 10-17 and the shaft 28. The use of the sliding bearings 29-36 and 48 provides a significant reduction of these losses.

The theoretical required power for operation of the centrifugal generator of a thrust force can be presented in accordance with the following formula
N₁=f(KₐᵥmARn³),
wherein K—an average value of a coefficient of friction;
m—weight of a work mass;
A—magnitude of eccentricity between an axis of the shaft and the center of a ring guide;
R—radius of a ring guide;
n—revolutions of shaft rotation.

The thrust force generated by the centrifugal generator can be presented as in accordance with the following formula:
P=f(mARn²).

Calculated value of the ratio

$$E = \frac{P}{N}$$

depends on a number of revolution.

The computation of the generator of a thrust force having a radius of a ring guide 1 m, weight of work mass 1 kg, eccentricity 0.7 m, and coefficient of friction K=0.05, result in the following:

$${E}_{n - 1000} = ∼ 14 \frac{KG}{hp} {E}_{n - 5000} = ∼ 6 \frac{Kg}{hp} .$$

These values of efficiency for a centrifugal generator of a thrust force with a drive of lever type with floating rods exceeds the same parameters of all known apparatuses for generation of a thrust force.

High efficiency, simple construction, possibility to change direction and magnitude of a thrust force, and the main feature of independence of a thrust force from the flight speed and condition of surrounding medium, can provide wide application of centrifugal generators of a thrust force with a drive of a lever type with floating rods, not only in the aviation and space travels, but also in other areas.

It will be understood that each of the elements described above, or two or more together, may also find a useful application in other types of constructions differing from the types described above.

While the invention has been illustrated and described as embodied in a centrifugal generator of a thrust force for aviation and space apparatuses , it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A centrifugal generator of a thrust force for aviation and space flight, comprising a housing; an integrating element; work masses; a drive, said integrating element being composite and arranged in said housing with a possibility of a forced reciprocating displacement along parallel guides and has an annular guide formed by two identical annular grooves which surround console parts of said work masses with a clearance, said drive being formed as a lever-type drive with floating rods, that are provided with end stops with dampers and extending through an axis of a shaft and central parts of said work masses, said rods being arranged in pairs parallel to one another and in said pairs are located at a same distance from an axis of symmetry of said drive and arranged in pairs with a uniform angle of displacement, said rods interacting with said shaft and said work masses through sliding bearings, said rods having a length which provides a clearance of said console parts of said work masses when said console parts of opposing ones of said work masses lest are in contact in a position of a maximum distance from one another.

2. A centrifugal generator as defined in claim 1, wherein said composite integrating element together with a mechanism of a reciprocating movement and said parallel guides are arranged in said housing with said possibility of a forced rotary movement over an angle +/−90° relative to said axis of rotation of said drive.

3. A centrifugal generator as defined in claim 1, wherein said work masses have a central part which is formed as an aerodynamic profile.

4. A centrifugal generator as defined in claim 1; and further comprising means for mounting on a space apparatus with a possibility of a forced turning by an angle +/−90° relative to an axis which is perpendicular to said shaft of said drive.

5. A centrifugal generator as defined in claim 1, wherein said annular grooves have a rectangular cross-section.

6. A flying apparatus, comprising a body; and a centrifugal generator of a thrust force, said generator including a housing; an integrating element; work masses; a drive, said integrating element being composite and arranged in said housing with a possibility of a forced reciprocating displacement along parallel guides and has an annular guide formed by two identical annular grooves which surround console parts of said work mass with a clearance, said drive being formed as a lever-type drive with floating rods, that are provided with end stops with dampers and extending through an axis of a shaft and central parts of said work masses, said rods being arranged in pairs parallel to one another and in said pairs are located at a same distance from an axis of symmetry of said drive and arranged in pairs with a uniform angle of displacement, said rods interacting with said shaft and said work masses through sliding bearings, said rods having a length which provides a clearance of said console parts of said work masses when said console parts of opposite ones of said work masses are located opposite in a position of a maximum distance from one another.
